(19) United States
(12) Patent Application Publication
(10) Pub. No.: US 2011/0196084 A1
(43) Pub. Date: Aug. 11, 2011

(54) AQUEOUS CROSSLINKABLE VINYL GRAFT COPOLYMER COMPOSITIONS

(76) Inventors: Tijs Nabuurs, Waalwijk (NL); Saskia Carolien Slot, Van Der, Waalwijk (NL); Gerardus Cornelis Overbeek, Waalwijk (NL)

(21) Appl. No.: 12/306,204

(22) PCT Filed: Jun. 19, 2007
(86) PCT No.: PCT/EP07/05387

§ 371 Date: May 2, 2011

(30) Foreign Application Priority Data
Jun. 23, 2006 (EP) 06012958.2

(51) Int. Cl. C08L 51/06; C09D 151/06; C08F 2/22; C09D 11/10; C09J 151/06

(52) U.S. Cl. 524/458; 524/533; 524/523

(57) ABSTRACT

An aqueous composition comprising: A) a crosslinkable vinyl graft copolymer comprising 30 to 85 wt % of a polymeric backbone; and 70 to 15 wt % of at least one macromonomer grafted to the polymeric backbone, where the Tg of the macromonomer is in the range of from 15 to 140° C.; where the Tg of the polymeric backbone is ≦40° C.; where the vinyl graft copolymer comprises 0.6 to 10 wt % of at least one carbonyl functional vinyl monomer; where the polymeric backbone contains ≧75% of the carbonyl functional vinyl monomers in the vinyl graft copolymer; and B) a hydrazide functional compound; where the ratio of hydrazide functional groups to carbonyl functional groups in the vinyl graft copolymer is in the range of from 0.1 to 1.5; and where the composition comprises ≦50 wt % of organic co-solvent by weight of the vinyl graft copolymer.

The present invention relates to certain aqueous crosslinkable vinyl graft copolymer compositions, to a process for the production of such aqueous crosslinkable vinyl graft copolymer compositions and to their use.

The use of aqueous vinyl polymer compositions is well known in the art for numerous applications, and in particular for the provision of a binder material in coating applications. Generally elongation is a desirable property in a coating, especially if the coating is applied to natural substrates such as for example wood and leather. Furthermore it is useful to have a reasonable degree of hardness in a coating so as to reduce blocking and dirt pick-up as well as to improve resistances. However it has been found that hardness and elongation have an inverse relationship where an increase in hardness usually results in a decrease in elongation and vice versa.

It is also known to be advantageous in some applications to employ an aqueous vinyl graft copolymer composition.

WO 06/007999 discloses an aqueous composition comprising a vinyl graft copolymer, where the copolymer comprises a polymeric backbone and a macromonomer which is obtained by using at least two different vinyl monomer feeds.

WO 93/22351 and WO 93/22355 disclose the use of a macromonomer prepared having terminal ethylenic unsaturation acting as a chain transfer agent for controlling the molecular weight of polymers prepared in the presence of the macromonomer.

U.S. Pat. No. 6,248,826 discloses an aqueous dispersed copolymer formed by emulsion polymerisation of terminally unsaturated carboxylic acid oligomers with ethylenically unsaturated vinyl monomers so as to have low viscosities over a broad pH range.

WO 95/32228 and WO 95/32229 describe aqueous coating and lacquer compositions comprising a graft copolymer having carboxylic-acid functional macromonomer attached at a terminal end thereof to a polymeric backbone.

U.S. Pat. No. 5,231,131 describes a pigment dispersion containing a graft copolymer dispersant having a hydrophobic backbone and hydrophilic macromonomer side chains. Both the macromonomer and backbone are prepared in solvent.

We have now discovered how to prepare aqueous crosslinkable vinyl graft copolymer compositions where the mechanical and physical properties such as for example hardness, chemical resistances and elongation are easily tailorable and furthermore where a significant improvement in the balance between hardness and elongation may be obtained.

According to the present invention there is provided an aqueous composition comprising:

A) a crosslinkable vinyl graft copolymer comprising:
a) 30 to 85 wt % of a polymeric backbone; and
b) 70 to 15 wt % of at least one macromonomer grafted to the polymeric backbone:
where a) and b) add up to 100%;
where the Tg of the macromonomer is in the range of from 15 to 140° C.;
where the Tg of the polymeric backbone is ≦40° C.;
where the vinyl graft copolymer comprises 0.6 to 10 wt % of at least one carbonyl functional vinyl monomer;
where the polymeric backbone contains ≧75% of the carbonyl functional vinyl monomers in the vinyl graft copolymer; and

B) a hydrazide functional compound;
where the ratio of hydrazide functional groups to carbonyl functional groups in the vinyl graft copolymer is in the range of from 0.1 to 1.5;
and where the composition comprises ≦50 wt % of organic co-solvent by weight of the vinyl graft copolymer.

Preferably the crosslinkable vinyl graft copolymer is an ambient temperature crosslinkable vinyl graft copolymer. By this is meant that it can crosslink at an ambient temperature even if in practice heating is used to speed up drying. By ambient temperature is meant 20+/−3° C.

For clarity, the terms: a vinyl graft copolymer, a vinyl monomer, a polymeric backbone and a macromonomer are intended to cover the singular as well as the plural.

The aqueous composition of the invention may be a solution, dispersion, emulsion or suspension of the vinyl graft copolymer in an aqueous carrier medium. Preferably the aqueous composition of the invention comprises 0 to 50 wt %, more preferably 0 to 40 wt % and most preferably 0 to 35 wt % of organic co-solvent by weight of the vinyl graft copolymer.

The weight % ratio of macromonomer to polymeric backbone is preferably in the range of from 20:80 to 60:40, more preferably 25:75 to 55:45 and most preferably between 35:65 to 45:55.

The Tg of a macromonomer or polymeric backbone herein stands for the calculated glass transition temperature and is well known to be the temperature at which a polymer changes from a glassy, brittle state to a rubbery state. Tg values may be calculated using the well-known Fox equation. Thus the Tg, in degrees Kelvin, of a copolymer having “n” copolymerised comonomers is given by the weight fractions W of each comonomer type and the Tg's of the homopolymers (in degrees Kelvin) derived from each comonomer according to the equation:

1/Tg═W₁/Tg₁+W₂/Tg₂+ . . . Wₙ/Tgₙ.

The calculated Tg in degrees Kelvin may be readily converted to ° C.

Preferably the Tg of the macromonomer is in the range of from 30° C. to 110° C. and more preferably in the range of from 30° C. to 90° C. It has been found that at a macromonomer Tg in the range of from 60° C. to 90° C. the König hardness of a film obtained from the invention composition is improved. Furthermore it has been found that at a macromonomer Tg in the range of from 30° C. to 70° C. the balance of the elongation and König hardness of a film obtained from the invention composition is improved.

Preferably the Tg of the polymeric backbone is ≦15° C., more preferably in the range of from −65° C. to 0° C. and most preferably in the range of from −25° C. to 0° C.

An advantage of a lower Tg of the polymeric backbone is that the elastic properties of resultant films are at least maintained and are often improved. This needs to be balanced with the required König hardness, as a higher Tg polymeric backbone usually results in an increased König hardness of the resultant film.

Preferably the average Tg of the macromonomer is at least 15° C. and more preferably at least 30° C. higher than the Tg of the polymeric backbone. An advantage of a macromonomer with a higher Tg than the Tg of the polymeric backbone is that improved König hardness may be obtained.

Weight average molecular weights (Mw) of the macromonomer and the vinyl graft copolymer may be determined by using gel permeation chromatography (GPC) using a polymer, such as polystyrene, of known molecular weight as a standard and THF as an eluent.

Preferably the Mw of the macromonomer is in the range of from 5,000 g/mol and 150,000 g/mol, more preferably 15,000 g/mol to 125,000 g/mol and most preferably 65,000 g/mol and 115,000 g/mol. An advantage of a higher Mw macromonomer is that an improved König hardness, blocking resistance and scratch resistance may be obtained.

Preferably the composition of the invention is a one pack combination of the crosslinkable vinyl graft copolymer and the hydrazide functional compound. This means that the reactive components co-exist in a single composition and are shelf-stable, that is to say that they do not prematurely react (to an extent where the film properties become negatively affected) until the composition is exposed to the atmosphere and begins to dry out.

Preferred crosslinking mechanisms include ambient temperature curable mechanisms comprising the reaction of functional groups such as carbonyl groups and hydrazide groups; carbonyl groups and semi carbazide groups; carbonyl groups and hydrazine groups or oxyamine groups; and more preferably the crosslinking mechanisms comprises the reaction of functional groups such as carbonyl groups and hydrazide groups; and carbonyl groups and semi-carbazide groups.

The presence of carbonyl functional groups in the polymeric backbone to provide crosslinking on drying of the composition has the advantage that the elastic properties of resultant films are at least maintained and are often improved. Furthermore the presence of carbonyl functional groups in the polymeric backbone to provide crosslinking on drying of the composition has the advantage that the König hardness of the resultant films is improved.

The macromonomer and the polymeric backbone of the vinyl graft copolymer are derived from free-radically polymerisable olefinically unsaturated monomers, which are also usually referred to as vinyl monomers, and can contain polymerised units of a wide range of such vinyl monomers, especially those commonly used to make binders for the coatings industry.

Examples of vinyl monomers which may be used to form the polymeric backbone and/or the macromonomer include but are not limited to olefinically unsaturated vinyl monomers such as 1,3-butadiene, isoprene, divinyl benzene, aromatic vinyl monomers such as styrene, α-methyl styrene; vinyl monomers such as acrylonitrile, methacrylonitrile; vinyl halides such as vinyl chloride; vinylidene halides such as vinylidene chloride; vinyl esters such as vinyl acetate, vinyl propionate, vinyl laurate; vinyl esters of versatic acid such as VeoVa 9 and VeoVa 10 (VeoVa is a trademark of Resolution); heterocyclic vinyl compounds; alkyl esters of mono-olefinically unsaturated dicarboxylic acids such as di-n-butyl maleate and di-n-butyl fumarate and, in particular, esters of acrylic acid and methacrylic acid of formula CH₂═CR⁵—COOR⁴ wherein R⁵ is H or methyl and R⁴ is optionally substituted C₁ to C₂₀, more preferably C₁ to C₈, alkyl, cycloalkyl, aryl or (alkyl)aryl which are also known as acrylic monomers, examples of which are methyl (meth)acrylate, ethyl (meth)acrylate, butyl (meth)acrylate (all isomers), 2-ethylhexyl (meth)acrylate, isopropyl (meth)acrylate, propyl (meth)acrylate (all isomers), and hydroxyalkyl (meth)acrylates such as hydroxyethyl (meth)acrylate, 2-hydroxypropyl (meth)acrylate, 4-hydroxybutyl (meth)acrylate and their modified analogues like Tone M-100 (Tone is a trademark of Union Carbide Corporation).

Particularly preferred is a polymeric backbone and/or a macromonomer made from a vinyl monomer system comprising at least 40 wt %, more preferably at least 50 wt % and especially at least 60 wt % of one or more vinyl monomers of the formula CH₂═CR⁵COOR⁴ as defined above. Such a preferred polymeric backbone and/or macromonomer is defined herein as an acrylic polymeric backbone and an acrylic macromonomer respectively. Particularly preferred acrylic monomers include butyl (meth)acrylate (all isomers), methyl (meth)acrylate, octyl (meth)acrylate (all isomers) and ethyl (meth)acrylate. Other preferred vinyl monomers include (meth)acrylic amides, (meth)acrylonitrile and vinyl acetate. The other vinyl monomers in such acrylic polymeric backbones and/or macromonomer may include one or more of the other vinyl monomers mentioned above, and/or may include ones different to such other vinyl monomers.

The vinyl monomers may also include vinyl monomers carrying functional groups as exemplified below. Such functional vinyl monomers may be introduced directly in the vinyl graft copolymer by free radical polymerisation, or alternatively the functional group may be introduced by a reaction of a reactive precursor into the macromonomer or polymeric backbone using a reactive compound carrying a functional group.

For the sake of clarity by a carbonyl functionality in this specification (unless specified otherwise) is meant the carbonyl functionality of a ketone or aldehyde group. Such carbonyl functional groups in a vinyl polymer are normally chain-pendant and/or terminal groups.

Examples of vinyl monomers which bear carbonyl functional groups include acrolein, methacrolein, crotonaldehyde, 4-vinylbenzaldehyde, vinyl alkyl ketones of 4 to 7 carbon atoms such as vinyl methyl ketone. Further examples include acrylamidopivalaldehyde, methacrylamidopivalaldehyde, 3-acrylamidomethyl-anisaldehyde, diacetone acrylate and diacetone methacrylate, and keto-containing amides such as diacetone acrylamide (DAAM).

A preferred vinyl monomer carrying carbonyl functional groups is diacetone acrylamide.

Preferably the vinyl graft copolymer comprises 1.5 to 6 wt % and more preferably 2 to 4.5 wt % of carbonyl functional vinyl monomer(s);

Preferably the macromonomer comprises 0 to 20 wt %, more preferably 0 to 10 wt %, especially 0 to 3 wt % and most preferably 0 wt % of carbonyl functional vinyl monomer(s).

Preferably the polymeric backbone comprises 0.6 to 20 wt %, more preferably 1.2 to 20 wt % and most preferably 2 to 20 wt % of carbonyl functional vinyl monomer(s).

Preferably the polymeric backbone contains ≧80%, more preferably ≧90% and especially 100% of the carbonyl functional vinyl monomer(s) in the vinyl graft copolymer.

The polymeric backbone and/or macromonomer may optionally contain other functional groups.

Water-dispersing functional groups provide the facility of self-dispersibility, stability, solubility in water and/or a substrate. The water dispersing groups may be ionic, potentially ionic, non-ionic or a mixture of such water-dispersing groups. Ionic water-dispersing groups need to be in their dissociated (i.e. salt) form to effect their water-dispersing action. If they are not dissociated they are considered as potential ionic groups which become ionic upon dissociation. The ionic water-dispersing groups are preferably fully or partially in the form of a salt in the final composition of the invention. Ionic water-dispersing groups include cationic water-dispersing groups such as basic amine groups, quaternary ammonium groups and anionic water-dispersing groups such as acid groups, for example phosphoric acid groups, sulphonic acid groups, and carboxylic acid groups. Conversion to the salt form is described below. Preferably any ionic water-dispersing groups are anionic water-dispersing groups.

Preferred vinyl monomers providing anionic or potentially anionic water-dispersing groups include (meth)acrylic acid, itaconic acid, maleic acid, β-carboxyethyl acrylate, monoalkyl maleates (for example monomethyl maleate and monoethyl maleate), citraconic acid, styrenesulphonic acid, vinylbenzylsulphonic acid, vinylsulphonic acid, acryloyloxyalkyl sulphonic acids (for example acryloyloxymethyl sulphonic acid), 2-acrylamido-2-alkylalkane sulphonic acids (for example 2-acrylamido-2-methylethanesulphonic acid), 2-methacrylamido-2-alkylalkane sulphonic acids (for example 2-methacrylamido-2-methylethanesulphonic acid), mono(acryloyloxyalkyl)phosphates (for example, mono(acryloyloxyethyl)phosphate and mono(3-acryloyloxypropyl)phosphates) and mono(methacryloyloxyalkyl)phosphates.

The polymeric backbone and/or macromonomer may comprise functional vinyl monomers that may become cationic upon addition of acid, such as dimethylaminoethyl (meth)acrylate, dimethylaminopropyl (meth)acrylate, and dimethylaminopropyl (meth)acrylamide. Such potentially ionic functional vinyl monomers may contribute to improved adhesion and may also improve stability or appearance on specific substrates such as wood.

Preferably the vinyl graft copolymer comprises 0 to 20 wt %, more preferably 0 to 15 wt % and most preferably 0 to 10 wt % of vinyl monomers carrying anionic water-dispersing groups.

Preferably the macromonomer comprises 0 to 10 wt %, more preferably 0 to 8 wt % and most preferably 0 wt % of vinyl monomers carrying anionic water-dispersing groups.

Preferably the polymeric backbone comprises 0 to 20 wt %, more preferably 0 to 15 wt %, most preferably 0 to 10 wt % and especially 0 to 5 wt % of vinyl monomers carrying anionic water-dispersing groups.

Non-ionic water-dispersing groups may be in-chain, pendant or terminal groups. Preferably non-ionic water-dispersing groups are pendant polyoxyalkylene groups, more preferably polyoxyethylene groups such as methoxy(polyethyleneoxide (meth)acrylate) or hydroxyalkyl (meth)acrylates such as hydroxyethyl (meth)acrylate (HE(M)A).

Preferred vinyl monomers providing non-ionic water-dispersing groups include alkoxy polyethylene glycol (meth)acrylates, hydroxy polyethylene glycol (meth)acrylates, alkoxy prolyproplene glycol (meth)acrylates and hydroxy polypropylene glycol (meth)acrylates, preferably having a number average molecular weight of from 350 to 3000 g/mol. Examples of such vinyl monomers which are commercially available include ω-methoxypolyethylene glycol (meth)acrylate. Other vinyl monomers providing non-ionic water-dispersing groups include (meth)acrylamidemono(methacryloyloxethyl)phosphate).

Such non-ionic functional vinyl monomers may contribute to improved stability and improved pigment and substrate wetting.

Preferably the vinyl graft copolymer comprises 0 to 20 wt %, more preferably 0 to 15 wt %, most preferably 0 to 10 wt %, especially 0 to 5 wt % and most especially 0 wt % of vinyl monomers carrying non-ionic water-dispersing groups.

Preferably the macromonomer comprises 0 to 15 wt %, more preferably 0 to 10 wt % and most preferably 0 to 5 wt % of vinyl monomers carrying non-ionic water-dispersing groups.

Preferably the polymeric backbone comprises 0 to 20 wt %, more preferably 0 to 15 wt %, most preferably 0 to 10 wt % and especially 0 to 5 wt % of vinyl monomers carrying non-ionic water-dispersing groups.

Preferably the macromonomer is a macromonomer of Formula (1)

CH₂═C(R¹)—CF₁₂—[X]ₘ (1)

Where
R¹=optionally substituted aryl, —C(O)OR² or —C(O)NR², R³;
R²=—H, —CH₃ or optionally substituted C₁ to C₁₈ alkyl, cycloalkyl, aryl (alkyl)aryl;
R³=—H, —CH₃ or optionally substituted C₁ to C₁₈ alkyl, cycloalkyl, aryl (alkyl)aryl;
X=residue of vinyl monomer; and
m=an integer in the range of from 2 to 1750.

Preferably m is in the range of from 20 to 1300 and more preferably m is in the range of from 70 to 900.

Preferably the macromonomer of Formula I comprises:
i) 10 to 98 wt % of CH₂═CR⁶—COOR⁷ where R⁶ is H or methyl and R⁷ is optionally substituted alkyl or cycloalkyl of 1 to 20 carbon atoms;
ii) 0 to 40 wt % of aromatic vinyl monomers;
iii) 0 to 10 wt % of vinyl monomers carrying anionic water-dispersing groups;
iv) 0 to 20 wt % of carbonyl functional vinyl monomers;
v) 0 to 20 wt % of vinyl monomers not in i) to iv);
   where i)+ii)+iii)+iv)+v) add up to 100%.

Preferably the polymeric backbone comprises:
i) 10 to 98 wt % of CH₂═CR⁶—COOR⁷ where R⁶ is H or methyl and R⁷ is optionally substituted alkyl or cycloalkyl of 1 to 20 carbon atoms;
ii) 0 to 40 wt % of aromatic vinyl monomers;
iii) 0 to 20 wt % of vinyl monomers carrying anionic water-dispersing groups;
iv) 0.6 to 20 wt % of carbonyl functional vinyl monomers;
v) 0 to 88.8 wt % of vinyl monomers not in i) to iv);
   where i)+ii)+iii)+iv)+v) add up to 100%.

General methods for preparing aqueous vinyl polymers are reviewed in the Journal of Coating Technology, volume 66, number 839, pages 89 to 105 (1995).

The macromonomer and the polymeric backbone are preferably prepared by free radical polymerisation. The free radical polymerisation can be performed by techniques well known in the art, for example, by emulsion polymerisation, solution polymerisation, suspension polymerisation or bulk polymerisation. Furthermore the free radical polymerisation may be carried out as a batch or as a semi-continuous polymerisation process.

The macromonomer may be prepared by any known technique and may include directly synthesising the macromonomer in an aqueous process, i.e. in the presence of water (for example by emulsion polymerisation, suspension polymerisation, micro-suspension polymerisation or mini emulsion polymerisation), or by solution polymerisation where the solution may be water or any organic solvent. If the solution is water the monomers are preferably soluble in water. Preferably the macromonomer is prepared by solution polymerisation, emulsion polymerisation or suspension polymerisation. Preferably the macromonomer is prepared by an aqueous process. Preferably the continuous phase of the aqueous process comprises ≧50 wt %, more preferably ≧80 wt % and most preferably ≧95 wt % of water. Most preferably the macromonomer is prepared by an aqueous emulsion polymerisation process.

Preferably the polymeric backbone is prepared in an aqueous process. Preferably the polymeric backbone is prepared by solution polymerisation or emulsion polymerisation. Most preferably the polymeric backbone is prepared by an aqueous emulsion polymerisation process.

The process for preparing the vinyl graft copolymer may be carried out in a number of modes including but not limited to polymerising all of the macromonomer and vinyl monomers in one batch, pre-charging the macromonomer to a reactor and subsequently feeding in the vinyl monomers in one or more stages and/or using a gradient feeding technique (or vice versa), feeding both macromonomer and vinyl monomers to a reactor (optionally pre-charged with some macromonomer), preparing a vinyl graft copolymer by feeding the vinyl monomers to the macromonomer which is simultaneously fed into a reactor (optionally pre-charged with some macromonomer) or continuously feeding a mixture of macromonomer and vinyl monomers into a reactor.

Preferably the free-radical polymerisation is effected by heating the reactor contents to a temperature in the range of from 30 to 100° C. and more preferably in the range of from 30 to 90° C.

A free-radical polymerisation of vinyl monomers will require the use of free-radical-yielding initiator to initiate the vinyl polymerisation. Suitable free-radical-yielding initiators include inorganic peroxides such as K, Na or ammonium persulphate, hydrogen peroxide, or percarbonates; organic peroxides, such as acyl peroxides including e.g. benzoyl peroxide, alkyl hydroperoxides such as t-butyl hydroperoxide and cumene hydroperoxide; dialkyl peroxides such as di-t-butyl peroxide; peroxy esters such as t-butyl perbenzoate and the like; mixtures may also be used. The peroxy compounds are in some cases advantageously used in combination with suitable reducing agents (redox systems) such as Na or K pyrosulphite or bisulphite, and iso-ascorbic acid. Metal compounds such as Fe.EDTA (EDTA is ethylene diamine tetracetic acid) may also be usefully employed as part of the redox initiator system. Azo functional initiators may also be used. Preferred azo initiators include azobis(isobutyronitrile), 2,2′-azo-bis(2-methyl butane nitrile) (ANBN); and 4,4′-azobis(4-cyanovaleric acid). It is possible to use an initiator partitioning between the aqueous and organic phases, e.g. a combination of t-butyl hydroperoxide, iso-ascorbic acid and Fe.EDTA. The amount of initiator or initiator system to use is conventional, e.g. within the range 0.05 to 6 wt % based on the total vinyl monomer(s) used. Preferred initiators for preparing the macromonomer include ammonium persulphates, sodium persulphates, potassium persulphates, azobis(isobutyronitrile) and/or 4,4′-azobis(4-cyanovaleric acid). Preferred initiators for preparing the polymeric backbone include redox systems and persulphates as described above.

A further amount of initiator may optionally be added at the end of the polymerisation process to assist the removal of any residual vinyl monomers.

The macromonomer may be prepared by a number of processes including but not limited to the use of catalytic chain transfer agents, diarylethene or high temperature processes (such as those described in U.S. Pat. No. 5,710,227). Preferably catalytic chain-transfer polymerisation using a catalytic chain transfer agents is used.

To prepare a macromonomer a catalytic chain-transfer agent is preferably added to the free radical polymerisation process. The macromonomer is in this invention a vinyl polymer with a terminal unsaturated group which is preferably prepared by free-radical emulsion polymerisation or suspension polymerisation of at least two different vinyl monomer feeds in the presence of a catalytic chain transfer agent. Use of a catalytic chain-transfer agent allows control over the molecular weight of the macromonomer as well as creating terminal unsaturated groups. In catalytic chain-transfer polymerisation (CCTP) a free radical polymerisation is carried out using a free radical forming initiator and a catalytic amount of a selected transition metal complex acting as a catalytic chain transfer agent (CCTA), and in particular a selected cobalt chelate complex. Such a technique has been described fairly extensively in the literature within the last twenty years or so. For example, various literature references, such as N. S. Enikolopyan et al, J. Polym. Chem. Ed, Vol 19, 879 (1981), discloses the use of cobalt II porphyrin complexes as chain transfer agents in free radical polymerisation, while U.S. Pat. No. 4,526,945 discloses the use of dioxime complexes of cobalt II for such a purpose. Various other publications, e.g. U.S. Pat. No. 4,680,354, EP-A-0196783, EP-A-0199436 and EP-A-0788518 describe the use of certain other types of cobalt II chelates as chain-transfer agents for the production of oligomers of vinyl monomers by free radical polymerisation. WO-A-87/03605 on the other hand claims the use of certain cobalt III chelate complexes for such a purpose, as well as the use of certain chelate complexes of other metals such as iridium and rhenium.

The cobalt chelate complex used in the invention process is preferably a cobalt II chelate having the following formula III:

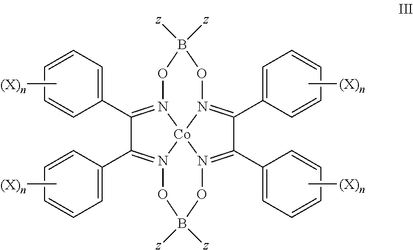

wherein each group X, independently in each ring and in different rings, is a substituent selected from any alkyl but preferably of 1 to 14 carbon atoms or cycloalkyl of 6 to 14 carbon atoms and any aryl but preferably of 6 to 14 carbon atoms;
n, independently in each ring, is 0 to 5;
Z, independently on each boron atom, is selected from F, Cl, Br, OH, alkoxy of 1 to 12 carbon atoms, aryloxy of 6 to 12 carbon atoms, alkyl of 1 to 12 carbon atoms and aryl of 6 to 12 carbon atoms;
or two Z groups taken together provide on one or both boron atoms a group —O-(T)-O— where T is a divalent aryl or alicyclic linking group or an alkylene linking group;
or two Z groups taken together on one or both boron atoms provide a 1,5-cycloctanediyl linking group;
or being a cobalt III analogue of said cobalt II chelate of formula III in which the cobalt atom is additionally covalently bonded, in a direction at right angles to the macrocyclic chelate ring system, to H, halide or other anion, or a homolytically dissociable organic group;
and wherein at least one further ligand may or may not be coordinated to the cobalt II or cobalt III atom, being a ligand(s) which does not alter the cobalt valency state.

The hydrophobic cobalt chelate may also be a Co II chelate having the following formula IV:

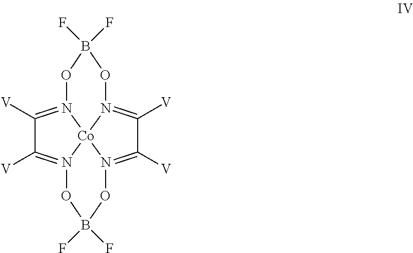

where V is any alkyl group of ≧4 carbon atoms.

Referring now to Formula III, preferably X is alkyl of 1 to 14 carbon atoms, and may be straight-chained or branched if the option arises. More preferably X is alkyl of 1 to 4 carbon atoms and particularly is methyl.

It is possible for n (representing the number of substituents in a ring) to be 0 in all rings (i.e. all the rings are unsubstituted so that each ring is phenyl).

Preferably, n is 1 to 5 in at least two rings and more preferably n is 1 to 5 in at least three rings and in particular n is 1 to 5 in all four rings.

Preferably n is 1 to 3 in a substituted ring, more preferably n being 1 or 2.

Preferably, when n is 1 to 3 in a substituted ring it has the same value in each ring (if more than one ring is substituted), and more preferably n is 1 or 2, and particularly n is 1 in each substituted ring.

When n=2, the substituents are preferably in the 3, 4 or 2, 4 positions.

When n=1, the substituent may be in the 2, 3 or 4 positions of a ring, preferably being at the same position in all substituted rings. It is particularly preferred that the substituent is at the 2, 3 or 4 position of all four rings, and especially at the 4 position of all four rings.

The groups Z are preferably all the same (or when taken together to form a divalent group such groups are the same on both boron atoms) and more preferably are all F.

When both Z groups together provide a group —O-(T)-O— where T is a divalent aryl or alicyclic linking group, the group T preferably has 6 to 10 carbon atoms and in such cases linkage is from adjacent ring carbon atoms; more preferably T is o-phenylene or 1,2-cyclohexanediyl.

It is more preferred that the Co chelate of Formula III has the following specific Formula V corresponding to Co II (bis 4,4′-dimethylbenzildioxime diborondifluoride):

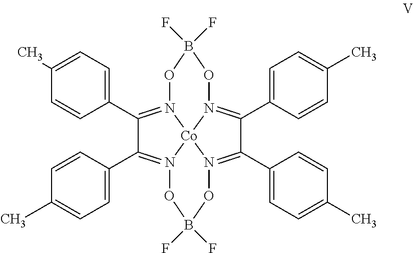

Specific examples of such hydrophobic Co chelate complexes of Formula III where X is alkyl are disclosed in U.S. Pat. No. 5,962,609.

Preferably in the range of from 0 to 100 wt ppm of catalytic chain-transfer agents based on the weight of vinyl monomer required for the macromonomer is used, more preferably ≦60 wt ppm, most preferably ≦35 wt ppm and especially ≦20 wt ppm is used.

The preferred process for preparing a macromonomer is using a free-radical-initiated aqueous emulsion polymerisation in a polymerisation reactor of at least one vinyl monomer, which process employs a Co chelate complex as a CCTA, a stabilising substance for the emulsion polymerisation process and a vinyl monomer feed stage wherein an aqueous pre-emulsified mixture, comprising at least part of the Co chelate employed, at least part of the stabilising substance employed and (i) a non-polymerisable organic solvent and/or (ii) a polymerisable vinyl monomer in unpolymerised or at least partially polymerised form, is contacted in the reactor with vinyl monomer feed stage at the beginning of and/or during the course of the vinyl monomer feed stage.

Furthermore, if used, the cobalt chelate catalysts may be added in stages between the vinyl monomer feeds.

Preferably when using a cobalt chelate catalyst the ratio of acrylic to methacrylic vinyl monomers is in the range of from 40:60 to 100:0 for the polymeric backbone.

Preferably when using a cobalt chelate catalyst the ratio of acrylic to methacrylic vinyl monomers is in the range of from 0:100 to 40:60 for the macromonomer.

In a further preferred embodiment of the invention the macromonomer is prepared by the use of diarylethene. The use of diarylethene is described in detail in W. Bremser et al, Prog. Org. Coatings, 45, (2002, 95 and

JP 3135151, DE 10029802 and US 2002/0013414. Examples of diarylethene include but are not limited to diphenylethene. Preferably ≦7.5 wt %, more preferably ≦5 wt %, especially ≦3 wt % and most especially 0.5 to 2.5 wt % of diarylethene, based on the weight of vinyl monomers required for the macromonomer, is used.

Optionally the macromonomer is obtained using at least two different vinyl monomer feeds by which is meant that the macromonomer is preferably prepared using a sequential polymerisation process or a gradient polymerisation process to give a gradient polymeric morphology. The macromonomer may also be obtained by a blend of at least two macromonomers where each macromonomer is obtained from a different vinyl monomer feed. Optionally if the macromonomer is obtained by such a blend of at least two macromonomers then the macromonomers are each obtained by a solution polymerisation process, blended and then dispersed in an aqueous medium. This ensures an intimate blend of the macromonomers to be grafted to the polymeric backbone. Optionally at least one of the macromonomers is obtained using at least two different vinyl monomer feeds.

Sequential polymerisations are well known in the art and are described in, for example, EP 492301 and are defined as polymerisations carried out using at least two feeds where the second vinyl monomer feed is added when most or all of the first vinyl monomer feed has been reacted.

The macromonomer prepared using a gradient process may be prepared by any of the process variations (also often described as a power feed process) as disclosed in U.S. Pat. No. 3,804,881, U.S. Pat. No. 4,195,167 and WO 97/12921.

A typical gradient process for preparing a macromonomer comprises introducing a first vinyl monomer feed to a reactor, where the first vinyl monomer feed continually varies in its composition due to the addition of a different second vinyl monomer feed to the first vinyl monomer feed and polymerising the vinyl monomers introduced into the reactor.

If two vinyl monomer feeds used to prepare the macromonomer they preferably differ in their composition.

Molecular weight control additional to that provided by catalytic chain-transfer agents may be provided by using additional chain-transfer agents such as mercaptans and halogenated hydrocarbons as exemplified below. Preferably ≦2 wt % by weight of chain-transfer agent based on vinyl monomers required for the macromonomer is used, more preferably ≦1 wt %, most preferably ≦0.5 wt % and especially 0 wt % is used. After the macromonomer has been formed the vinyl monomers required for the polymeric backbone are added to the macromonomer and are preferably polymerised by a free radical aqueous emulsion or suspension polymerisation in the presence of a conventional initiator.

To prepare the polymeric backbone a chain-transfer agent may be added to control the molecular weight of the polymeric backbone. Suitable chain-transfer agents include mercaptans such as n-dodecylmercaptan, n-octylmercaptan, t-dodecylmercaptan, mercaptoethanol, iso-octyl thioglycolurate, C₂ to C₈ mercapto carboxylic acids and esters thereof such as 3-mercaptopropionic acid and 2-mercaptopropionic acid; and halogenated hydrocarbons such as carbon tetrabromide and bromotrichloromethane.

Preferably ≦5 wt % of chain-transfer agent based on vinyl monomers required for the polymeric backbone is used, more preferably ≦4 wt % and most preferably ≦3 wt %.

In another embodiment of the present invention there is provided a process for the preparation of an aqueous composition according to the invention said process comprising the steps:
I) polymerising:
   i) 10 to 98 wt % of CH₂═CR⁶—COOR⁷ where R⁶ is H or methyl and R⁷ is optionally substituted alkyl or cycloalkyl of 1 to 20 carbon atoms;
   ii) 0 to 40 wt % of aromatic vinyl monomers;
   iii) 0 to 10 wt % of vinyl monomers carrying anionic water-dispersing groups;
   iv) 0 to 20 wt % of carbonyl functional vinyl monomers;
   v) 0 to 20 wt % of vinyl monomers not in i) to iv);
   where i)+ii)+iii)+iv)+v) add up to 100%;
   to obtain a macromonomer;
II) polymerising in the presence of the macromonomer vinyl monomers comprising:
   i) 10 to 98 wt % of CH₂═CR⁶—COOR⁷ where R⁶ is H or methyl and R⁷ is optionally substituted alkyl or cycloalkyl of 1 to 20 carbon atoms;
   ii) 0 to 40 wt % of aromatic vinyl monomers;
   iii) 0 to 20 wt % of vinyl monomers carrying anionic water-dispersing groups;
   iv) 0.6 to 20 wt % of carbonyl functional vinyl monomers;
   v) 0 to 88.8 wt % of vinyl monomers not in i) to iv);
   where i)+ii)+iii)+iv)+v) add up to 100%;
   to obtain the polymeric backbone.

The grafting between the macromonomer and the polymeric backbone preferably takes place during the preparation of the polymeric backbone.

Surfactants can be utilised in order to assist in the dispersion of the emulsification of the vinyl graft copolymer in water (even if it is self-dispersible). Suitable surfactants include but are not limited to conventional anionic, cationic and/or non-ionic surfactants and mixtures thereof such as Na, K and NH₄ salts of dialkylsulphosuccinates, Na, K and NH₄ salts of sulphated oils, Na, K and NH₄ salts of alkyl sulphonic acids, Na, K and NH₄ alkyl sulphates, alkali metal salts of sulphonic acids; fatty alcohols, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups, phosphoric acid analogues and phosphates or carboxylic acid groups. Cationic surfactants include alkyl or (alk)aryl groups linked to quaternary ammonium salt groups. Non-ionic surfactants include polyglycol ether compounds and preferably polyethylene oxide compounds as disclosed in “non-ionic surfactants—Physical chemistry” edited by M. J. Schick, M. Decker 1987. The amount of surfactant used is preferably 0 to 15 wt %, more preferably 0 to 8 wt %, still more preferably 0 to 5 wt %, especially 0.1 to 3 wt % and most especially 0.3 to 2 wt % based on the weight of the vinyl graft copolymer.

By a hydrazide functional compound is meant a compound bearing a carbonyl-reactive functional group of formula —NHNH₂ and also a carbonyl-reactive hydrazone group derived from such a group by reaction with a monoketone or monoaldehyde of at least two carbon atoms. It will become apparent that such functional groups are usually part of larger groups, such as those of formulae, —R—C(═O)—NH—NH₂, —R—C(═O)—NH—N═C<, —R—NH—C(═O)NH—NH₂, —R—NH—C(═O)—NH—N═C<, and —R—NH—NH₂ where R is optionally substituted alkylene, optionally substituted alicyclic, or optionally substituted aryl.

Preferred hydrazide functional compounds include but are not limited to dicarboxylic acid bis-hydrazides, bis-hydrazones, specific examples being oxalic acid dihydrazide, malonic acid dihydrazide, succinic acid dihydrazide, adipic acid dihydrazide, phthalic acid dihydrazide, terephthalic acid dihydrazide, glutaric acid dihydrazide and sebacic acid dihydrazide, cyclohexane dicarboxylic acid bis-hydrazides, azelaic acid bis-hydrazides; also carbonic acid hydrazides, bis-semicarbazides, trihydrazides, dihydrazinoalkones and dihydrazines of aromatic hydrocarbons, for example 1,4-dihydrazinobenzene and 2,3-dihydrazinonophthalene, dihydrazine and others known in the art. More preferred examples include adipic acid dihydrazide, succinic acid dihydrazide and glutaric acid dihydrazide.

Preferably the ratio of hydrazide functional groups to carbonyl functional groups in the vinyl graft copolymer is in the range of from 0.2 to 0.95 and most preferably 0.55 to 0.8.

If desired the aqueous composition of the invention can be used in combination with other polymer compositions which are not according to the invention. Furthermore the composition of the invention is particularly suitable for use in coatings or coating compositions in which it may provide a key part of coating compositions or formulations. Such coating compositions can be pigmented or unpigmented.

The aqueous composition of the present invention may be applied to a variety of substrates including wood, board, metals, stone, concrete, glass, cloth, leather, paper, plastics, foam and the like, by any conventional method including brushing, dipping, flow coating, spraying, flexo printing, gravure printing, ink-jet printing, any other graphic arts application methods and the like. The aqueous carrier medium is removed by natural drying or accelerated drying (by applying heat) to form a coating.

Accordingly, in a further embodiment of the invention there is provided a coating, a polymeric film, a printing ink and/or an overprint lacquer obtainable from an aqueous composition of the present invention.

It has also been found that the aqueous composition of the invention is suitable for use as an adhesive, accordingly there is also provided an adhesive obtainable from an aqueous composition of the present invention. Types of adhesives include pressure sensitive adhesives, hot melt, contact and laminating adhesives.

The aqueous composition of the invention may contain conventional ingredients, some of which have been mentioned above; examples include pigments, dyes, emulsifiers, surfactants, plasticisers, thickeners, heat stabilisers, levelling agents, anti-cratering agents, fillers, sedimentation inhibitors, UV absorbers, antioxidants, drier salts, organic co-solvents, wetting agents and the like introduced at any stage of the production process or subsequently. It is possible to include an amount of antimony oxide in the dispersions to enhance the fire retardant properties.

Suitable organic co-solvents which may be added during the process or after the process during formulation steps are well known in the art and include xylene, toluene, methyl ethyl ketone, acetone, diethylene glycol and 1-methyl-2-pyrrolidinone.

Optionally an external crosslinking agent may be added to the aqueous composition of the invention to aid crosslinking during or after drying.

The solids content of the aqueous composition of the invention is preferably within the range of from 20 to 60 wt % and most preferably within the range of from 30 to 50 wt %.

The present invention is now illustrated by reference to the following examples. Unless otherwise specified, all parts, percentages and ratios are on a weight basis. The term comparative means that it is not according to the invention and is denoted with a C.

In the examples, the following abbreviations and terms are specified:
MMA methyl methacrylate
AAEM acetoacetoxyethyl methacrylate
BA n-butyl acrylate
BMA n-butyl methacrylate
2-EHMA 2-ethylhexyl methacrylate
DAAM diacetone acrylamide
MAA methacrylic acid
AA acrylic acid
MM macromonomer
BB polymeric backbone
SLS sodium lauryl sulphate (surfactant 30% solution in water)
APS ammonium persulphate (initiator)
ADH adipic dihydrazide
   Cobalt chelate complex=Co II (bis 4,4′-dimethylbenzildioxime diborondifluoride) as disclosed in U.S. Pat. No. 5,962,609.

### Preparation of Hydrophilic Oligomer HO1

A hydrophilic oligomer for use as a stabilising substance in the invention process was prepared using the following procedure. In a round-bottomed flask equipped with a stirrer and reflux condenser, 1044.1 parts of water and 1.64 parts of SLS and 0.59 parts of APS were mixed and heated to 85° C. 5 wt % a pre-emulsified feed of 473.5 parts of MMA, 46.2 parts of MAA, 57.7 parts of AAEM, 238.5 parts of water, 9.3 parts of SLS and 15.6 parts of 3-mercaptopropionic acid was added to the reactor phase at 60° C. At reaction temperature the remaining monomer feed was added over a period of 60 minutes. An initiator feed of 1.37 parts of APS dissolved in 141.1 parts of water was added over a period of 70 minutes. When the initiator feed had been completed the reaction mixture was kept at 85° C. for 20 minutes. After 20 minutes the temperature was reduced to 60° C. The pH of the reactor phase was increased to 8 using a mixture of 45.48 parts aqueous NH₃ (25 wt % in water) and 36.25 parts of water. A solution of 0.82 parts of sodium metabisulphite in 13.6 parts of water was fed to the reactor phase in 45 minutes, directly after the start of this feed a slurry of 0.78 parts of t-butyl hydroperoxide and 2.27 parts of water was added. This was repeated after 15 and 30 minutes after the start of the sodium metabisulphite feed. After completion of the sodium metabisulphite feed the reactor phase was cooled to 30° C. and filtered. The final product had a pH of 8.0 and a solids content of 30 wt % The molecular weight of the hydrophilic oligomer HO1 was 12,000 g/mol.

### Preparation of the Macromonomer for Example C1-C6 and G1-G6

In a round-bottomed flask equipped with a stirrer and reflux condenser 64.40 of oligomer material HO1 (30 wt % solids) was mixed with a preformed solution of 0.003 parts of cobalt chelate complex and 19.32 parts of MMA at room temperature. After mixing for 1 hour at room temperature the emulsified mixture was diluted with 1632.70 parts of water and heated to 75° C. thereby forming a pre-emulsified mixture. At 75° C., 7.73 parts of an APS solution (2.5 wt % in water, pH=8.5) was added to the reactor phase to start the polymerisation in the pre-emulsified mixture in the reactor. The reactor phase was further heated to 85° C. The reactor phase was kept at 85° C. for 10 minutes. At this point, addition of 772.83 parts of a vinyl monomer feed with the composition as described in table 1 and a separate APS initiator feed, comprising 146.84 parts of an APS solution (2.5 wt % in water) and 32.20 parts of SLS (30 wt % solution in water) at a pH of 8.5, to the reactor were started. The vinyl monomer feed and separate initiator feed were added over a period of 240 minutes. Following the addition of the vinyl monomer feed the vinyl monomer feed tank was rinsed with 73.98 parts of water. The polymerisation mixture kept at 85° C. for 90 minutes. The emulsion was cooled to room temperature and filtered. The macromonomer had a sediment content of 0.1 wt % before filtration, a pH in the range of 8.0 to 8.5, a viscosity of 15 mPa·s, a solids content of 30 wt % and a weight average molecular weight as measured by GPC of around 100 000 g/mol.

### Preparation of the Macromonomer Used for Example C7-C8 and G7

In a round-bottomed flask equipped with a stirrer and reflux condenser 45.77 of oligomer material HO1 (30 wt % solids) was mixed with a preformed solution of 0.0027 parts of cobalt chelate complex and 13.73 parts of MMA at room temperature. After mixing for 1 hour at room temperature the emulsified mixture was diluted with 973.03 parts of water and heated to 75° C. thereby forming a pre-emulsified mixture. At 75° C., 5.49 parts of an APS solution (2.5 wt % in water, pH=8.5) was added to the reactor phase to start the polymerisation in the pre-emulsified mixture in the reactor. The reactor phase was further heated to 85° C. The reactor phase was kept at 85° C. for 10 minutes. At this point, addition of 549.29 parts of a vinyl monomer feed with the composition as described in table 2 and a separate APS initiator feed, comprising 104.37 parts of an APS solution (2.5 wt % in water) and 18.12 parts of SLS (30 wt % solution in water) at a pH of 8.5, to the reactor were started. The vinyl monomer feed and separate initiator feed were added over a period of 240 minutes. Following the addition of the vinyl monomer feed the vinyl monomer feed tank was rinsed with 90.00 parts of water. The polymerisation mixture kept at 85° C. for 90 minutes. The emulsion was cooled to room temperature and filtered. The macromonomer had a sediment content of 0.1 wt % before filtration, a pH in the range of 8.0 to 8.5, a viscosity of 10 mPa·s, a solids content of 32.5 wt % and a weight average molecular weight as measured by GPC of around 120 000 g/mol.

### Preparation of a Vinyl Graft Copolymer (Example C1-C6 and G1-G6)

In a round-bottomed flask (the reactor) equipped with a stirrer and reflux condenser 657.95 parts of macromonomer dispersion, 11.51 parts of SLS (30 wt % solution in water) and 102.89 parts of water were mixed. The reactor phase was heated to 50° C. At this temperature 197.38 parts of a monomer mixture with the composition as described in Table 1 below was added to the reactor phase. The reactor phase mixed for 1 hour at 50° C. After 1 hour, 15.79 parts of an isoascorbic acid solution (2.5 wt % in water, pH=8.5) was added to the reactor phase followed by 1.97 parts of a t-butyl hydroperoxide solution (30 wt % in water). The polymerisation reaction was initiated with 0.3 parts of a solution of Fe(EDTA) (1 wt % in water). The batch became exothermic, the temperature increased to 80° C. After the peak temperature was reached the reactor phase was kept at 80° C. for 30 minutes. After 30 minutes 7.90 parts of an isoascorbic acid solution (2.5 wt % in water, pH=8.5) was added to the reactor phase followed by 0.66 parts of a t-butyl hydroperoxide solution (30 wt % in water). The reactor phase was kept at 80° C. for 30 minutes. The emulsion was cooled to room temperature. The pH was adjusted to pH of 7.5 with ammonia. 3.95 parts of Proxel Ultra 10 was added. 1.78 parts of ADH was added. After mixing for another 20 minutes at room temperature, the emulsion was filtered. The vinyl graft copolymers had a sediment content of 0.1 wt % before filtration, a pH in the range of 7.0 to 7.5 and a viscosity of 300 mPa-s and a solids content of 40 wt %.

### Preparation of a Vinyl Graft Copolymer (Example C7-C8 and G7)

In a round-bottomed flask (the reactor) equipped with a stirrer and reflux condenser 607.64 parts of macromonomer dispersion, 11.52 parts of SLS (30 wt % solution in water) and 153.74 parts of water were mixed. The reactor phase was heated to 50° C. At this temperature 197.48 parts of a monomer mixture with the composition as described in Table 2 below was added to the reactor phase. The reactor phase mixed for 1 hour at 55° C. After 1 hour, 15.79 parts of an isoascorbic acid solution (2.5 wt % in water, pH=8.5) was added to the reactor phase followed by 1.32 parts of a t-butyl hydroperoxide solution (30 wt % in water). The batch became exothermic, the temperature increased to 80° C. After the peak temperature was reached the reactor phase was kept at 80° C. for 30 minutes. After 30 minutes 7.90 parts of an isoascorbic acid solution (2.5 wt % in water, pH=8.5) was added to the reactor phase followed by 0.66 parts of a t-butyl hydroperoxide solution (30 wt % in water). The reactor phase was kept at 80° C. for 30 minutes. The emulsion was cooled to room temperature. The pH was adjusted to pH of 7.0-7.5 with ammonia. 3.95 parts of Proxel Ultra 10 (biocide available from Arch Chemicals) was added. 3.56 parts of ADH was added. After mixing for another 20 minutes at room temperature, the emulsion was filtered. The vinyl graft copolymers had a sediment content of 0.1 wt % before filtration, a pH in the range of 7.0 to 7.5, a viscosity of 20 mPa·s and a solids content of 40 wt %.

### Formulation of the Coating Compositions

The example emulsions of the invention and the comparative example emulsions were formulated with coalescent. To an emulsion was added drop wise 10 wt % on total emulsion of butyl diglycol and optionally 1 wt % of Dehydran 1293 (wetting agent available from Cognis). The butyl diglycol was adjusted to a pH of 7 using ammonia.

The formulated emulsions were allowed to stand at room temperature for 24 hours and then were cast with a blade roller (400 μm wet) on glass coated with release paper or (80 μm wet) direct on glass. The resultant films were dried at room temperature after which they were annealed at 52° C. for 16 hours (all the resultant films were tack-free). König hardness and elongation were determined and the results are shown in Table 3 and 4 below.

TABLE 1

| | Composition MM | | Composition BB | | | |
|---|---|---|---|---|---|---|
| Example | wt % | | wt % | | | |
| No. | MMA | 2-EHMA | MMA | BA | AA | DAAM |
| C1 | 52.5 | 47.5 | 65 | 29 | 6 | — |
| G1 | 52.5 | 47.5 | 63 | 28.5 | 6 | 2.5 |
| C2 | 52.5 | 47.5 | 54 | 40 | 6 | — |
| G2 | 52.5 | 47.5 | 52 | 39.5 | 6 | 2.5 |
| C3 | 52.5 | 47.5 | 41 | 53 | 6 | — |
| G3 | 52.5 | 47.5 | 39 | 52.5 | 6 | 2.5 |
| C4 | 33.7 | 47.5 | 65 | 29 | 6 | — |
| G4 | 33.7 | 47.5 | 63 | 28.5 | 6 | 2.5 |
| C5 | 33.7 | 47.5 | 54 | 40 | 6 | — |
| G5 | 33.7 | 47.5 | 52 | 39.5 | 6 | 2.5 |
| C6 | 33.7 | 47.5 | 41 | 53 | 6 | — |
| G6 | 33.7 | 47.5 | 39 | 52.5 | 6 | 2.5 |

TABLE 2

| | Composition MM | | | Composition BB | | | |
|---|---|---|---|---|---|---|---|
| Example | wt % | | | wt % | | | |
| No. | MMA | BMA | DAAM | MMA | BA | AA | DAAM |
| C7 | 59.2 | 40.8 | — | 44 | 53 | 3 | — |
| C8 | 56.3 | 38.7 | 5 | 44 | 53 | 3 | — |
| G8 | 59.2 | 40.8 | — | 39.8 | 52.2 | 3 | 5 |

### Test Methods

### Sediment

Sediment is unstabilised solid material (in the order of microns rather than nanometers) which is formed during dispersing or reaction and which will settle or precipitate upon storage and/or heating. It may be determined quantitatively by centrifuging. The sediment content was determined by taking 50 cm³ of the resultant dispersion of the examples prepared above, diluting this with water (1:1) and centrifuging the diluted composition for 15 minutes at 1500 rpm (276 G) in a centrifuge tube.

Each division on the tube tip represents 0.05 cm³ or 0.05% sediment. The outcome, i.e. the level of solid sediment in the tube tip was then multiplied by 2 to take into account the dilution factor.

König Hardness

König hardness as used herein is a standard measure of hardness, being a determination of how the viscoelastic properties of a film formed from the dispersion slows down a swinging motion deforming the surface of the film, and is measured according to DIN 53157 NEN 5319 using an Erichsen hardness equipment.

### Tensile Tests

A 400 micron wet film of the formulated aqueous coating composition of the invention was dried for 4 hours at room temperature, followed by 16 hours annealing at 52° C. A halter according to DIN 52 910-53 was prepared. Elongation of the free film was determined using an Instron optical tension meter.

### GPC

The weight average molecular weight Mw was determined by means of GPC by using THF as an eluent and polystyrene as a standard polymer. The given molecular weight data are polystyrene equivalent molecular weights.

TABLE 3

| Example | wt % DAAM | wt % DAAM | König hardness | Elongation |
|---|---|---|---|---|
| No. | in MM | in BB | (s) | (%) |
| C1 | 0 | 0 | 99 | 144 |
| G1 | 0 | 2.5 | 150 | 157 |
| C2 | 0 | 0 | 97 | 168 |
| G2 | 0 | 2.5 | 144 | 200 |
| C3 | 0 | 0 | 57 | 280 |
| G3 | 0 | 2.5 | 112 | >300 |
| C4 | 0 | 0 | 94 | 157 |
| G4 | 0 | 2.5 | 125 | 166 |
| C5 | 0 | 0 | 62 | 200 |
| G5 | 0 | 2.5 | 87 | 268 |
| C6 | 0 | 0 | 42 | >300 |
| G6 | 0 | 2.5 | 57 | >300 |

TABLE 4

| Example | wt % DAAM | wt % DAAM | König hardness | Elongation |
|---|---|---|---|---|
| No. | in MM | in BB | (s) | (%) |
| C7 | 0 | 0 | 125 | 25 |
| C8 | 5 | 0 | 115 | 55 |
| G8 | 0 | 5 | 160 | 110 |

1. An aqueous composition comprising
A) a crosslinkable vinyl graft copolymer comprising:
a) 30 to 85 wt % of a polymeric backbone; and
b) 70 to 15 wt % of at least one macromonomer grafted to the polymeric backbone:
where a) and b) add up to 100%;
where the Tg of the macromonomer is in the range of from 15 to 140° C.;
where the Tg of the polymeric backbone is ≦40° C.;
where the vinyl graft copolymer comprises 0.6 to 10 wt % of at least one carbonyl functional vinyl monomer;
where the polymeric backbone contains ≧75% of the carbonyl functional vinyl monomers in the vinyl graft copolymer; and
B) a hydrazide functional compound;
where the ratio of hydrazide functional groups to carbonyl functional groups in the vinyl graft copolymer is in the range of from 0.1 to 1.5;
and where the composition comprises ≦50 wt % of organic co-solvent by weight of the vinyl graft copolymer.

2. An aqueous composition according to claim 1 wherein the carbonyl functional vinyl monomer is selected from the group consisting of acrolein, methacrolein, crotonaldehyde, 4-vinylbenzaldehyde, C4 to C8 vinyl alkyl ketones, acrylamidopivalaldehyde, methacrylamidopivalaldehyde, 3-acrylamidomethyl-anisaldehyde, diacetone acrylate, diacetone methacrylate, keto-containing amides and mixtures thereof.

3. An aqueous composition according to claim 1 wherein the hydrazide functional compound is selected from the group consisting of oxalic acid dihydrazide, malonic acid dihydrazide, succinic acid dihydrazide, adipic acid dihydrazide, phthalic acid dihydrazide, terephthalic acid dihydrazide, glutaric acid dihydrazide, sebacic acid dihydrazide, cyclohexane dicarboxylic acid bis-hydrazides, azelaic acid bis-hydrazides, carbonic acid hydrazides, bis-semicarbazides, trihydrazides, dihydrazinoalkones, dihydrazines of aromatic hydrocarbons and mixtures thereof.

4. An aqueous composition according to claim 1 wherein the crosslinkable vinyl graft copolymer is an ambient temperature crosslinkable vinyl graft copolymer.

5. An aqueous composition according to claim 1 wherein the weight % ratio of macromonomer to polymeric backbone is in the range of from 20:80 to 60:40.

6. An aqueous composition according to claim 1 wherein the Tg of the polymeric backbone is ≦15° C.

7. An aqueous composition according to claim 1 wherein the average Tg of the macromonomer is at least 15° C. higher than the Tg of the polymeric backbone.

8. An aqueous composition according to claim 1 wherein the Tg of the macromonomer is in the range of from 30 to 70° C.

9. An aqueous composition according to claim 1 wherein the Tg of the macromonomer is in the range of from 60 to 90° C.

10. An aqueous composition according claim 1 wherein the Mw of the macromonomer is in the range of from 5,000 g/mol to 150,000 g/mol.

11. An aqueous composition according to claim 1 wherein the macromonomer is of Formula (1)
CH₂═C(R¹)—CH₂—[X]ₘ (1)
where
R¹=optionally substituted aryl, —C(O)OR² or —C(O)NR², R³;
R²=—H, —CH₃ or optionally substituted C₁ to C₁₈ alkyl, cycloalkyl, aryl (alkyl)aryl;
R³=—H, —CH₃ or optionally substituted C₁ to C₁₈ alkyl, cycloalkyl, aryl (alkyl)aryl;
X=residue of vinyl monomer; and
m=an integer in the range of from 2 to 1750.

12. A process for the preparation of an aqueous composition according to claim 1 said process comprising the steps:
I) polymerising:
i) 10 to 98 wt % of CH₂═CR⁶—COOR⁷ where R⁶ is H or methyl and R⁷ is optionally substituted alkyl or cycloalkyl of 1 to 20 carbon atoms;
ii) 0 to 40 wt % of aromatic vinyl monomers;
iii) 0 to 10 wt % of vinyl monomers carrying anionic water-dispersing groups;
iv) 0 to 20 wt % of carbonyl functional vinyl monomers;
v) 0 to 20 wt % of vinyl monomers not in i) to iv);
where i)+ii)+iii)+iv)+v) add up to 100%;
to obtain a macromonomer;
II) polymerising in the presence of the macromonomer vinyl monomers comprising:
i) 10 to 98 wt % of CH₂═CR⁶—COOR⁷ where R⁶ is H or methyl and R⁷ is optionally substituted alkyl or cycloalkyl of 1 to 20 carbon atoms;
ii) 0 to 40 wt % of aromatic vinyl monomers;
iii) 0 to 20 wt % of vinyl monomers carrying anionic water-dispersing groups;
iv) 0.6 to 20 wt % of carbonyl functional vinyl monomers;
v) 0 to 88.8 wt % of vinyl monomers not in i) to iv);
where i)+ii)+iii)+iv)+v) add up to 100%;
to obtain the polymeric backbone.

13. A process according to claim 12 wherein the macromonomer obtained in step I) is prepared using an aqueous emulsion polymerisation process.

14. A process according to claim 12 wherein the polymeric backbone obtained in step II) is prepared using an aqueous emulsion polymerisation process.

15. A coating obtained from an aqueous composition according to claim 1.

16. Use of the aqueous composition according to claim 1 as an adhesive.

17. Use of the aqueous composition according to claim 1 in formulating a polymeric film, a printing ink and/or an overprint lacquer.
